(19) United States
(12) Patent Application Publication
(10) Pub. No.: US 2011/0230610 A1
(43) Pub. Date: Sep. 22, 2011

(54) POLYMER BLEND FOR MATTE INJECTION MOULDED PARTS

(75) Inventors: Klaus Schultes, Wiesbaden (DE); Michael Wicker, Seeheim-Jugenheim (DE); Peter Kempf, Rodenbach (DE); Werner Hoß, Shanghai (CN); Klaus Albrecht, Mainz (DE); Ursula Golchert, Dieburg (DE); Stefan Nau, Buettelborn (DE)

(73) Assignee: ROEHM GMBH & CO. KG, Darmstadt (DE)

(21) Appl. No.: 13/115,446

(22) Filed: May 25, 2011

Related U.S. Application Data
(63) Continuation of application No. 10/575,929, filed on Apr. 14, 2006, now abandoned.

(30) Foreign Application Priority Data
Oct. 17, 2003 (DE) 103 49 144.9

(51) Int. Cl. C08L 33/12; C08L 83/00; C08K 5/05

(52) U.S. Cl. 524/385; 525/100; 525/207; 524/506; 524/517

(57) ABSTRACT

The invention relates to a polymer mixture, comprising
a) a polymer matrix which is composed of a (meth)acrylate (co)polymer or of a mixture of (meth)acrylate (co)polymers with a Vicat softening point VSP (ISO 306-B50) of at least 104° C. and/or of a (meth)acrylimide (co)polymer,
b) an impact modifier which is based on crosslinked poly(meth)acrylates and which does not have covalent bonding to the polymer matrix a),
c) from 1 to 15% by weight of plastics particles composed of crosslinked polymers based on polymethyl methacrylate, on polystyrene and/or on polysilicones.

The polymer mixture can be used to obtain injection mouldings with matt surfaces and Vicat softening points VSPs (ISO 306-B50) of at least 90° C.

The invention relates to a polymer mixture for matt injection-moulded parts, and also to the corresponding injection-moulded parts and their use.

### PRIOR ART

On the basis of the requirement for increasing low fuel consumption, the automotive industry is constantly attempting to make further reductions in the deadweight of motor vehicles. Whereas the parts used for construction of motor vehicle exteriors were previously very substantially composed of steel, it is desirable for economic reasons to have the capability of producing these elements from materials of lower density, while at the same time reducing production cost.

The property profile of these mouldings is determined by low deadweight together with high weathering resistance, high stiffness, good impact strength, good dimensional stability, in particular even on heating to the continuous operating temperature range, good chemical resistance, e.g. with respect to cleaning compositions, and good scratch resistance. Parts required here are not only glossy parts but also parts with matt surfaces.

EP 0 528 196 A1 describes a matt polymethacrylate film. This is composed of a coherent hard phase whose glass transition temperature is above 70° C. The hard phase is composed of a polymethacrylate matrix with, dispersed therein, a single- or two-phase tough phase composed of a rubber, at least 15% of this phase having covalent linkage to the hard phase. To make the film matt, from 0.1 to 70% by weight of a matting agent on the basis in the form of crosslinked polymethacrylate particles are present. The particle sizes of the matting agent are in the range from 1 to 150 μm, preferably from 1 to 10 μm. The difference between the refractive index of the thermoplastic matrix polymer and the matting agent is to be not more than 0.02, in order to avoid clouding of the film material. Extrusion of corresponding polymer mixtures and polishing in a polishing roller stack using high-gloss roller surfaces nevertheless gives films with a matt surface. The roughness values R_{z} to DIN 4768 here are in the range from 0.01 to 50 μm, for example 1.7 μm. Hard-phase polymers are used here at glass transition temperatures of, by way of example, 90° C., and these may comprise tough-phase fractions with glass transition temperatures of −35° C.

JP-A (Laid Open Patent Application) H1-287161, Patent Appl. 63-34877 Appl. No. 63-275381, Kyowa Gasu Kagaku Kogyo K.K.) describes an acrylic plastic composition for thermoplastic processing to give plastics parts with matt surfaces. As alternatives to processes in which matt plastics parts are produced from polymethyl methacrylate by means of mechanical effects, e.g. via embossing of matt structures into smooth film webs by means of roughened embossing rollers in a polishing roller stack, the intention was to provide moulding compositions where the matt finish automatically arises during their use without these mechanical effects. This is achieved by treating a polymethyl methacrylate matrix with crosslinked plastics particles based on polymethacrylate with a median particle size in the range from 1 to 50 μm at concentrations of from 0.5 to 15% by weight, and preparing a corresponding thermoplastically processable moulding composition therefrom. By way of example, the polymethyl methacrylate matrix may be composed of 95% by weight of methyl methacrylate and 5% by weight of methyl acrylate. If corresponding moulding compositions are used in injection moulding, injection mouldings with matt surfaces are obtained even with injection moulds having mirror-polished surfaces in their internal mould cavities. The roughness values R_{z} to DIN 4768 here are, by way of example, in the range from about 1 to 5 μm, depending on the proportion of the matting agent.

### Object and Achievement of Object

The prior art cited above, EP 0 528 196 A1 and JP-A H1-287161, discloses polymer mixtures based on poly(meth)acrylates, where matt mouldings, films or injection-moulded parts can be obtained by means of conventional thermoplastic processing without mechanical measures for producing matt structures. However, it has been found that the teachings of EP 0 528 196 A1 and JP-A H1-287161 have only restricted, or no, transferability to mouldings, in particular injection mouldings, which are intended to have matt surfaces and which are at the same time subject to particularly stringent materials requirements in relation to heat resistance and, where appropriate, other critical mechanical properties. If use is made of known matrix materials having high heat resistance and based on polymethacrylate with Vicat softening points of 104° C. or above, it is difficult or impossible to achieve the desired matt finish. The prior art cannot therefore yet comply with many of the currently prevailing requirement profiles, e.g. for matt exterior parts of motor vehicles.

Starting from, by way of example, EP 0 528 196 A1 and JP-A H1-287161, therefore, the object was to provide thermoplastically processable polymer mixtures whose use can give, by way of example in injection moulding, parts which have matt surfaces and at the same time have high capability to resist mechanical and/or chemical/physical effects. In particular, the parts are intended to be suitable for use as exterior parts in the automotive sector.

The object is achieved by way of a polymer mixture, comprising
a) a polymer matrix which is composed of a (meth)acrylate (co)polymer or of a mixture of (meth)acrylate (co)polymers with a Vicat softening point VSP (ISO 306-B50) of at least 104° C. and/or of a (meth)acrylimide (co)polymer,
b) an impact modifier which is based on crosslinked poly(meth)acrylates and which does not have covalent bonding to the polymer matrix a),
c) from 1 to 15% by weight of plastics particles composed of crosslinked polymers based on polymethyl methacrylate, on polystyrene and/or on polysilicones, with a median particle size in the range from 1 to 30 μm,
where a), b) and c) give a total of 100% by weight, and where the polymer mixture may also comprise conventional additives, auxiliaries and/or fillers, and a test specimen injection-moulded from the polymer mixture simultaneously has the following properties:
a roughness value R_{z} to DIN 4768 of at least 0.7 μm,
a gloss (R 60°) to DIN 67530 of at most 40, and also a Vicat softening point VSP (ISO 306-B50) of at least 90° C.

The invention starts by recognizing that when a highly heat-resistant matrix based on poly(meth)acrylate is combined with a matting agent otherwise suitable for these types of plastics, the result, after thermoplastic processing, is not the actual expected and desired matt finish.

By way of example, one reason for this could be that the particulate matting agents undergo mechanical deformation in the vicinity of the surface as a consequence of thermoplastic processing on exposure to the forces acting during those processes, and in particular are displaced under pressure into the matrix. When compared with less heat-resistant matrix materials based on poly(meth)acrylate, a highly heat-resistant matrix based on poly(meth)acrylate freezes more rapidly in the mould or on leaving the mould, and therefore particularly in the case of processing via injection moulding, the melt converts within fractions of a second from the molten state to a gel-like, relatively firm state. Whereas under other circumstances the mechanically deformed matting agents in the vicinity of the surface can recover after displacement into the matrix under pressure, in this physical condition recovery to their initial spherical condition is substantially prevented. The surface consequently remains substantially smooth. The use of a matting agent alone, e.g. as in JP-A H1-287161, is insufficient to produce a matt finish.

In order to permit mechanical recovery of the matting particles after thermoplastic processing on leaving the mould, despite the rapid freezing of the highly heat-resistant matrix, the polymer mixture comprises an impact modifier based on crosslinked poly(meth)acrylates.

However, the impact modifier selected differs from that in EP 0 528 196 A1 in that it does not have covalent bonding to the matrix. The result is greater freedom of movement for the particles within the matrix in the molten state. It is likely that an internal counterforce is produced on leaving the mould that, despite the rapid freezing of the highly heat-resistant matrix, is still sufficient to promote the recovery of deformed matting particles in the vicinity of the surface. At least some of the matting particles regain their initial spherical shape, whereupon they rise to some extent out of the matrix, and a matt finish thus arises.

### DESCRIPTION OF THE INVENTION

### The Polymer Mixture

The invention provides a polymer mixture, comprising
a) a polymer matrix which is composed of a (meth)acrylate (co)polymer or of a mixture of (meth)acrylate (co)polymers with a Vicat softening point VSP (ISO 306-B50) of at least 104° C. and/or of a (meth)acrylimide (co)polymer,
b) an impact modifier which is based on crosslinked poly(meth)acrylates and which does not have covalent bonding to the polymer matrix a),
c) from 1 to 15% by weight of plastics particles composed of crosslinked polymers based on polymethyl methacrylate, on polystyrene and/or on polysilicones, with a median particle size in the range from 1 to 30 μm,
where a), b) and c) give a total of 100% by weight, and where the polymer mixture may also comprise conventional additives, auxiliaries and/or fillers, and a test specimen injection-moulded from the polymer mixture simultaneously has the following properties:
a roughness value R_{z} to DIN 4768 of at least 0.7 μm,
a gloss (R 60°) to DIN 67530 of at most 40, and also a Vicat softening point VSP (ISO 306-B50) of at least 90° C.

The components may be present with the following quantitative proportions:
a) from 25 to 75% by weight
b) from 5 to 60% by weight
c) from 1 to 15% by weight.

By way of example, the dimensions of injection-moulded test specimens may be 110×110×3 mm, and these may be produced using a mirror-polished cavity. Examples of suitable equipment and production conditions are:

DEMAG D150 injection-moulding machine from Demag; melt temperature 250° C., mould temperature 70° C., injection pressure: from 120 to 160 bar, hold pressure: from 75 to 80 bar.

### The Polymer Matrix a)

The polymer matrix a) is composed of a (meth)acrylate (co)polymer or of a mixture of (meth)acrylate (co)polymers with a Vicat softening point VSP (ISO 306-B50) of at least 104° C. and/or of a (meth)acrylimide (co)polymer.

(Meth)Acrylate (co)Polymers Based on Methyl Methacrylate

The (meth)acrylate (co)polymer of the matrix may be a homopolymer or copolymer composed of at least 80% by weight of methyl methacrylate and, where appropriate, up to 20% by weight of other monomers copolymerizable with methyl methacrylate. The (meth)acrylate (co)polymer may be composed of from 80 to 100% by weight, preferably from 90 to 99.5% by weight, of free-radical-polymerized methyl methacrylate units and, where appropriate, of from 0 to 20% by weight, preferably from 0.5 to 10% by weight, of other comonomers capable of free-radical polymerization, e.g. C1-C4-alkyl (meth)acrylates, in particular methyl acrylate, ethyl acrylate or butyl acrylate. The average molar mass M_{w} of the matrix is preferably in the range from 90 000 to 200 000 g/mol, in particular from 95 000 to 180 000 g/mol.

The polymer matrix is preferably composed of a (meth)acrylate (co)polymer composed of from 96 to 100% by weight, preferably from 97 to 100% by weight, particularly preferably from 98 to 100% by weight, of methyl methacrylate and from 0 to 4% by weight, preferably from 0 to 3% by weight, in particular from 0 to 2% by weight, of methyl acrylate, ethyl acrylate and/or butyl acrylate.

The (meth)acrylate (co)polymers have a solution viscosity in chloroform at 25° C. (ISO 1628—Part 6) of from 45 to 80 ml/g, preferably from 50 to 75 ml/g. This can correspond to a molar mass M_{w} (weight-average) in the range from 80 000 to 200 000 (g/mol), preferably from 100 000 to 170 000 (g/mol). By way of example, the molar mass M_{w} may be determined by gel permeation chromatography or by a light scattering method (see, for example, H. F. Mark et al., Encyclopedia of Polymer Science and Engineering, 2^{nd} Edition, Vol. 10, pp. 1 et seq., J. Wiley, 1989).

The Vicat softening point VSP (ISO 306-B50) may be at least 104° C., preferably from 104 to 114° C., in particular from 105 to 110° C. The melt index MVR (ISO 1133, 230° C./3.8 kg) may, by way of example, be in the range from 0.5 to 6.0 cm³/10 min, preferably from 1.5 to 3.5 cm³/10 min.

(Meth)Acrylate (co)Polymers Containing Maleic Anhydride

The (meth)acrylate (co)polymer of the matrix may be a copolymer composed of methyl methacrylate, styrene and maleic anhydride.

The solution viscosity in chloroform at 25° C. (ISO 1628—Part 6) may be greater than or equal to 65 ml/g, preferably from 68 to 75 ml/g. This can correspond to a molar mass M_{w} (weight-average) of 130 000 g/mol (where M_{w} is determined by means of gel permeation chromatography on the basis of polymethyl methacrylate as calibration standard). By way of example, the molar mass M_{w} may be determined by gel permeation chromatography or by a light scattering method (see, for example, H. F. Mark et al., Encyclopedia of Polymer Science and Engineering, 2^{nd} Edition, Vol. 10, pp. 1 et seq., J. Wiley, 1989).

The Vicat softening point VSP (ISO 306-B50) may be at least 112° C., preferably from 114 to 124° C., in particular from 118 to 122° C. The melt index MVR (ISO 1133, 230° C./3.8 kg) may, by way of example, be in the range from 0.8 to 2.0 cm³/10 min, preferably from 1.0 to 1.5 cm³/10 min.

Examples of suitable constituent proportions may be:
from 50 to 90% by weight, preferably from 70 to 80% by weight, of methyl methacrylate,
from 10 to 20% by weight, preferably from 12 to 18% by weight, of styrene and
from 5 to 15% by weight, preferably from 8 to 12% by weight, of maleic anhydride.

Corresponding copolymers may be obtained in a manner known per se via free-radical polymerization. By way of example, EP-A 264 590 describes a process for preparing a moulding composition from a monomer mixture composed of methyl methacrylate, vinylaromatic compound, maleic anhydride and, where appropriate, from a lower alkyl acrylate, by carrying out the polymerization to 50% conversion in the presence or absence of a non-polymerizable organic solvent, and continuing the polymerization beyond a conversion of at least 50% in the temperature range from 75 to 150° C. in the presence of an organic solvent to at least 80% conversion, and then evaporating the low-molecular-weight volatile constituents.

JP-A 60-147 417 describes a process for preparing a highly heat-resistant polymethacrylate moulding composition by feeding, at a temperature of from 100 to 180° C., a monomer mixture composed of methyl methacrylate, maleic anhydride and at least one vinylaromatic compound into a polymerization reactor suitable for solution polymerization or bulk polymerization, and polymerizing the material. DE-A 44 40 219 describes another preparation process.

An example of a method for preparing component a) treats a monomer mixture composed of 3000 g of methyl methacrylate, 600 g of styrene and 400 g of maleic anhydride with 1.68 g of dilauroyl peroxide and 0.4 g of tert-butyl perisononanoate as polymerization initiator, 6.7 g of 2-mercaptoethanol as molecular weight regulator, and 4 g of 2-(2-hydroxy-5-methyl-phenyl)benzotriazole as UV absorber and 4 g of palmitic acid as mould-release agent.

The resultant mixture is charged to a polymerization cell and devolatilized for 10 minutes. Polymerization is then carried out in a water bath for 6 hours at 60° C. and 25 hours at a water bath temperature of 50° C. After about 25 hours, the polymerization mixture reaches its maximum temperature of 144° C.

Once the polymerization cell has been removed, the polymer is further heat-conditioned for 12 hours at 120° C. in a hot-air cabinet.

The resultant copolymer is clear and has a yellowness index to DIN 6167 (D65/10°) of 1.4 on a pressed plaque of thickness 8 mm and a light transmittance TD65 to DIN 5033/5036 of 90.9%. The Vicat softening point VSP of the copolymer to ISO 306-B50 is 121° C., and the reduced viscosity nsp/c is 65 ml/g corresponding to an average molecular weight M_{w} of about 130 000 daltons (based on a polymethyl methacrylate standard).

(Meth)Acrylimide (co)Polymers

The (meth)acrylate (co)polymer of the matrix may be a (meth)acrylimide (co)polymer. By way of example, EP-A 216 505, EP-A 666 161 or EP-A 776 910 disclose preparation processes for the polymethacrylimides mentioned.

The starting material used for the imidation process comprises a polymer which is derived from alkyl esters of methacrylic acid and which is generally composed of more than 50% by weight, preferably of more than 80% by weight, particularly preferably of from 95 to 100% by weight, of units of alkyl esters of methacrylic acid and from 1 to 4 carbon atoms in the alkyl radical. Methyl methacrylate is preferred. Preferred polymers are composed of at least 80% by weight, preferably more than 90% by weight, particularly preferably more than 95% by weight, of methyl methacrylate. Comonomers which may be used are any of the monomers copolymerizable with methyl methacrylate, in particular alkyl esters of acrylic acid having from 1 to 4 carbon atoms in the alkyl radical, acrylonitrile or methacrylonitrile, acrylamide or methacrylamide, styrene, or else maleic anhydride. Preference is given to thermoplastically processable polymers of this type whose reduced viscosity is in the range from 20 to 92 ml/g, preferably from 50 to 80 ml/g (measured to ISO 8257, Part 2). The form in which they are used is that of a powder or pellets with a median particle size of from about 0.03 to 3 mm.

It is significant that the first step (a) of the process uses ammonia as imidating agent and a subsequent step (b) of the process uses methylamine, and that the molar ratio of ammonia used to methylamine used is from 1:0.5 to 1:3, preferably from 1:0.8 to 1:2.7, particularly preferably from 1:0.9 to 1:1.1. Below this range, increased clouding of the resultant polymethacrylimide can occur. If there is a molar excess of methylamine, based on the ammonia used, the proportion of carboxylic acid groups in the polymer in turn rises undesirably.

The process may be carried out continuously or batchwise. In the latter case, the ammonia is added at the start of the reaction in step (a) of the process, and the methylamine is added gradually or in one or more portions in step (b) of the process, after reaction of the ammonia. By way of example, the imidating agent can be injected periodically or uniformly by a pressure pump into the reactor heated to reaction temperature. Where appropriate, prior to each addition of a further portion of the imidating agent the gas phase which has collected in the reactor is depressurized, thus removing from the reaction mixture the volatile reaction products formed by that time.

If the method of operation is continuous, the imidation is advantageously carried out in a tubular reactor, and the polymer and the imidating agent are continuously introduced into the tubular reactor. The first portion of the imidating agent, the ammonia, is introduced at a first inlet aperture and mixed with the molten polymer. Further portions of the imidating agent may be introduced into the tubular reactor at one or more locations where the imidating agent previously introduced has been reacted to some extent or completely. The tubular reactor used is preferably a single- or multiscrew extruder. Here again, compression zones and vent zones may alternate in order that, prior to each addition of further imidating agent, the volatile reduction products formed by that time are removed from the reaction mixture gradually conveyed through the extruder.

By way of example, 1 unit of polymethyl methacrylate (the term “unit” referring to the amount of ester monomer underlying the polymerized ester units) can be reacted with from 0.1 to 1 mol of ammonia in step (a) of the process. By way of example, good results are obtained with from 0.2 to 0.8 mol of ammonia, particularly preferably from 0.4 to 0.6 mol. The ammonia may preferably be added in from 1 to 5 additions. Once the ammonia has substantially reacted, the addition of methylamine then takes place in step (b) of the process in a molar ratio of from 0.5 to 3, preferably from 0.8 to 2.7, particularly preferably from 0.9 to 1.1, based on the total amount of ammonia used. It is particularly advantageous for the molar ratio of ammonia used to methylamine used to be from 1:0.5 to 1:0.8. The method for adding the methylamine may be similar, preferably in from 1 to 5 additions. Here again, it is advisable when adding partial amounts to use in each case only up to about 75% of the amount previously used.

The reaction with the imidating agent is preferably terminated before complete imidation of the polymer. To this end, the total amount of imidating agent used may, by way of example, be from 0.2 to 2.5 mol per ester unit, preferably from 0.5 to 1.5 mol, particularly preferably from 0.8 to 1.2 mol. However, the specified quantitative proportion of ammonia to methylamine is always to be maintained. This then gives polymers composed of from about 20 to 80 mol % of cyclic methacrylamide units and of only extremely small amounts of methacrylic acid units: below 0.5% by weight.

The imidation process may substantially be worked in a manner known per se, e.g. as described in EP 441 148. The imidation proceeds most effectively at temperatures above the melting point or at least 20° C. above the Vicat B softening point to ISO 306 of the starting polymer. It is still more effective to select a reaction temperature at least 20° C. above the softening point of the resultant imidated polymer. Since the Vicat softening point of the imidated polymer is generally the target parameter of the process, and the degree of imidation to be achieved is established accordingly, it is also easy to determine the minimum temperature required. Preference is given to a temperature range from 140 to 300° C., in particular from 150 to 260° C., particularly from 180 to 220° C. Excessive reaction temperatures sometimes reduce the viscosity as a consequence of some breakage of the polymer chains. In order to avoid exposing the polymer to excessive thermal stress, by way of example, the reaction temperature may start at a temperature just above the melting point of the starting polymer and be raised gradually or in stages, and only in a final stage exceed the softening point of the imidated final product by at least 20° C. Operations during the stages of the reaction are preferably carried out at autogenic pressure, which may be from 50 to 500 bar. By way of example, depressurization may be carried out during the stages of the process, for devolatilization purposes. During this process the temperature of the reaction mixture can fall and then has to be increased again to required value. If imidating agent is introduced under reaction conditions, the pressure used for this purpose must, of course, be appropriately high.

The reaction time depends on the reaction rate under the conditions used. It can be markedly shorter than the reaction time needed for complete imidation, but is always to be sufficient to ensure partial, e.g. from 20 to 80%, preferably from 30 to 60%, imidation of the polymer. The times generally sufficient for this purpose are from 10 sec to 30 min, preferably from 1 to 7 min, per stage of the process. A guideline value is from 4 to 6 min.

One or both stages of the process for the reaction may, if desired, be carried out in the presence of solvents or diluents, as disclosed by way of example in U.S. Pat. No. 2,146,209, DE 1 077 872, DE 1 088 231 or EP 234 726. Suitable solvents are especially those which are liquid at room temperature and are volatile at elevated temperature, where appropriate at subatmospheric pressure, and are easy to separate off from the imidated polymer. They may be solvents either for the starting polymer or for the imidated polymer, or for both, where appropriate only under reaction conditions, but this is not a fundamental requirement. Among the solvents and diluents which may be used are mineral oils, aromatic hydrocarbons, aromatic compounds, alkanols, ethers, ketones, esters, halogenated hydrocarbons, and water.

After the final stage of the reaction, the system is depressurized and the imidated polymer is cooled. A solvent or diluent used concomitantly here may be separated off together with excess imidating agent and eliminated alkanol, from the imidated polymer. The design of this stage of the process is particularly advantageous if at least the final stage of the process is carried out in a tubular reactor, in particular an extruder. The substances separated off from the polymer may be removed in liquid form or in vapour form upstream of the end of the tubular reactor at one or more locations where the polymer is still in the molten state. The first portion of these substances here may be removed under the full pressure of the reaction, and the final residues may be removed from a depressurization zone under subatmospheric pressure. Use may be made here of single- or multistage vent extruders known per se. Where appropriate, the entire reaction mixture may also be discharged from the tubular reactor, depressurized, cooled and pelletized, and only then separated from the ancillary constituents. To this end, the cooled and comminuted polymer may be washed with a suitable solvent or with water.

The resultant imidated product may be processed in a manner known per se, e.g. thermoplastically. Because the content of methacrylic acid groups in the polymer is extremely low, it has good miscibility and compatibility with other polymers. Weathering resistance is likewise very good, because there is a marked reduction in water absorption on exposure to moisture. The relatively high proportion of anhydride groups, when compared with the carboxyl groups, appears to have only an insignificant effect here. By way of example, one reason for this may be that the anhydride groups have relatively good protection from hydrolytic action by moisture in the interior of the polymer molecule. A poly-N-alkylmethacrylimide can be obtained in the high quality needed for industrial use in two easy steps of a process, by using the inventive process.

By way of example, U.S. Pat. No. 2,146,209 discloses the partial or complete imidation of polymers of alkyl esters of methacrylic acid via reaction with an imidating agent, e.g. a primary amine. The polymer is heated with the imidating agent, where appropriate under pressure, to temperatures of from 140 to 250° C., in the presence or absence of a solvent.

EP 216 505 discloses that polymethacrylimides are incompatible with other thermoplastic polymers if they contain more than from about 0.3 to 0.4 milliequivalents of carboxylic acid groups or carboxylic anhydride groups. This corresponds to a content of from 2.5 to 3.5% by weight of methacrylic acid units and/or of methacrylic anhydride units. These units are produced alongside poly-N-alkylmethacrylimide units during the reaction of polymethyl methacrylate with primary amines. At high imidation rates, i.e. if 95% or more of the imidatable groups of the polymer have been converted to imide groups, the content of carboxylic acid groups or of anhydride groups is generally below the abovementioned limit. However, lower degrees of imidation below 95% are often desired, and the increased formation of carboxylic acid groups or of anhydride groups is therefore problematic.

EP 456 267 (U.S. Pat. No. 5,135,985) describes poly-N-alkylmethacrylimides with less than 2.5% by weight of methacrylic acid units, and these can be prepared via homogeneous mixing of poly-N-alkylmethacrylimides with different degrees of imidation. This preparation method, too, is very complicated, because of the constant need to provide polymers with different degrees of imidation as raw materials for preparing a poly-N-alkylmethacrylimide.

EP 441 148 (U.S. Pat. No. 5,110,877) describes a process for imidating a polymer of alkyl esters of methacrylic acid by reaction with an imidating agent, by adding a portion of the imidating agent only after partial or complete reaction of the imidating agent previously added. Suitable imidating agents mentioned are ammonia or primary amines, e.g. methylamine. The process can prepare poly-N-alkylmethacrylimides with low contents of methacrylic acid units, 1.3 or 1.7% by weight, with degrees of imidation of about 80%. In contrast to this, the content of methacrylic acid units in the non-inventive standard process is given as 4.9% by weight.

According to the teaching of EP 216 505, the miscibility of poly-N-alkylmethacrylimides with other thermoplastic polymers is improved if the methacrylic acid units and/or methacrylic anhydride units are reacted via post-treatment of the polymer with an alkylating agent, such as orthoformic esters, giving methacrylic ester units. By way of example, poly-N-alkylmethacrylimides having less than 0.1 milliequivalents of acid groups per g (about 0.8% by weight) can be prepared with degrees of imidation of about 60% by weight. Although the post-alkylation is therefore highly effective it requires an additional and expensive step of the process.

In industry it is often found that carboxylic acid units are particularly disadvantageous in poly-N-alkylmethacrylimides. In contrast, the undesired effects of carboxylic anhydride groups present are within acceptable limits. The main requirement is therefore to prepare a polymethacrylamide having almost no carboxylic acid groups.

A process for preparing an imidated polymer of alkyl esters of methacrylic acid with less than 0.5% by weight content of carboxylic acid units, based on the polymer, via imidation of a polymer of alkyl esters of methacrylic acid in two steps (a) and (b) of a process can be characterized in that a first step of the process

(a) uses ammonia as imidating agent

and in the second step of the process

(b) methylamine is used as imidating agent

where the molar ratio of the ammonia used to the methylamine used is from 1:0.5 to 1:3.

The process is simple to work and provides poly-N-alkylmethacrylimides with degrees of imidation appropriate for industrial purposes, and having very good industrial properties, due to the low content of methacrylic acid units. It was unexpected here that the defined ratio of ammonia and methylamine in the steps (a) and (b) of the process appears to prevent side reactions which lead to the presence of methacrylic acid units in the final product. Astoundingly, the consequences of the relatively high content of carboxylic anhydride groups, from about 5 to 15% by weight, are less unfavourable than the prior art appears to suggest. The resultant polymers have high Vicat softening points and good processability.

The starting material used for the imidation comprises a polymer which derives from alkyl esters of methacrylic acid and which is generally composed of more than 50% by weight, preferably more than 80% by weight, particularly preferably from 95 to 100% by weight, of units of alkyl esters of methacrylic acid having from 1 to 4 carbon atoms in the alkyl radical. Methyl methacrylate is preferred. Preferred polymers are composed of at least 80% by weight, preferably more than 90% by weight, particularly preferably more than 95% by weight, of methyl methacrylate. Comonomers which may be used are any of the monomers copolymerizable with methyl methacrylate, in particular alkyl esters of acrylic acid having from 1 to 4 carbon atoms in the alkyl radical, acrylonitrile or methacrylonitrile, acrylamide or methacrylamide, styrene or else maleic anhydride. It is preferable to use thermoplastically processable polymers of this type whose reduced viscosity is in the range from 20 to 92 ml/g, preferably from 50 to 80 ml/g (measured to ISO 8257, Part 2). They are used in pulverulent or pelletized form with an median particle size of from about 0.03 to 3 mm.

Mixing of (meth)Acrylate (co)Polymers

The constituents a) and b) of the inventive polymer mixture may be introduced individually or in the form of a compounded material which comprises the following components d), e), f) and g). In this case, components d), f) and/or g) correspond to the polymer matrix a) of the inventive polymer mixture. Component e) corresponds to the impact modifier b) of the inventive polymer mixture. Components d), e), f) and g) are defined as follows:

d) a low-molecular-weight (meth)acrylate (co)polymer,

characterized by a solution viscosity in chloroform at 25° C. (ISO 1628—Part 6) smaller than or equal to 55 ml/g
e) an impact modifier based on crosslinked poly(meth)acrylates
f) a relatively high-molecular-weight (meth)acrylate (co)polymer,
   characterized by a solution viscosity in chloroform at 25° C. (ISO 1628—Part 6) smaller than or equal to 65 ml/g and/or
g) a (meth)acrylate (co)polymer other than d),
   characterized by a solution viscosity in chloroform at 25° C. (ISO 1628—Part 6) of from 50 to 55 ml/g
   where each of the components d), e), f) and/or g) may be an individual polymer or else a mixture of polymers,
   and where d), e), f) and/or g) give a total of 100% by weight,
   and where the polymer mixture of components d), e), f), and/or g) may also comprise conventional additives, auxiliaries and/or fillers and
   where a test specimen produced from the polymer mixture has one or more of the following properties:
   I. a tensile modulus (ISO 527) of at least 2600 MPa,
   II. a Vicat softening point VSP (ISO 306-B50) of at least 109° C.,
   III. an impact strength (ISO 179-2D, flatwise) of at least 17 kJ/m², and
   IV. a melt index MVR (ISO 1133, 230° C./3.8 kg) of at least 1.5 cm³/10 min.

### Component d)

Component d) is a low-molecular-weight (meth)acrylate

(co)polymer, characterized by a solution viscosity in chloroform at 25° C. (ISO 1628—Part 6) smaller than or equal to 55 ml/g, preferably smaller than or equal to 50 ml/g, in particular from 45 to 55 ml/g.

This can correspond to a molar mass M_{w} (weight-average) of 95 000 g/mol (M_{w} being determined by means of gel permeation chromatography with reference to polymethyl methacrylate as calibration standard). By way of example, the molar mass M_{w} may be determined by gel permeation chromatography or by a light scattering method (see, for example, H. F. Mark et al., Encyclopedia of Polymer Science and Engineering, 2^{nd} Edition, Vol. 10, pp. 1 et seq., J. Wiley, 1989).

Component d) is preferably a copolymer of methyl methacrylate, styrene and maleic anhydride.

By way of example, suitable constituent proportions can be:
from 50 to 90% by weight, preferably from 70 to 80% by weight, of methyl methacrylate,
from 10 to 20% by weight, preferably from 12 to 18% by weight, of styrene and
from 5 to 15% by weight, preferably from 8 to 12% by weight, of maleic anhydride.

Appropriate copolymers may be obtained in a manner known per se via free-radical polymerization. By way of example, EP-A 264 590 describes a process for preparing a moulding composition from a monomer mixture of methyl methacrylate, vinylaromatic compound and maleic anhydride, and also, where appropriate, from a lower alkyl acrylate, where the polymerization is carried out to 50% conversion in the presence or absence of a non-polymerizable organic solvent and where, beyond at least 50% conversion, the polymerization is continued in the temperature range from 75 to 150° C. in the presence of an organic solvent to at least 80% conversion, and then the low-molecular-weight volatile constituents are evaporated.

JP-A 60-147 417 describes a process for preparing a highly heat-resistant polymethacrylate moulding composition, where a monomer mixture of methyl methacrylate, maleic anhydride and at least one vinylaromatic compound are fed into, and polymerized in, a polymerization reactor suitable for solution or bulk polymerization at a temperature of from 100 to 180° C. DE-A 44 40 219 describes another preparation process.

By way of example, component d) may be prepared by treating a monomer mixture of, by way of example, 6355 g of methyl methacrylate, 1271 g of styrene and 847 g of maleic anhydride with 1.9 g of tert-butyl perneodecanoate and 0.85 g of tert-butyl 3,5,5-trimethylperoxyhexanoate as polymerization initiator and 19.6 g of 2-mercaptoethanol as molecular weight regulator, and also with 4.3 g of palmitic acid. The resultant mixture may be charged to a polymerization cell and devolatilized for 10 minutes, for example. The material may then be polymerized in a water bath, for example for 6 hours at 60° C., and then for 30 hours at 55° C. water bath temperature. After about 30 hours, the polymerization mixture reaches its maximum temperature, about 126° C. Once the polymerization cell has been removed from the water bath, the polymer is also heat-conditioned as appropriate for component a) in the polymerization cell for about 7 hours, for example at 117° C. in a hot-air cabinet.

### Component e)

Component e) is an impact modifier based on crosslinked poly(meth)acrylates. Component e) preferably has a two- or three-shell structure.

Impact modifiers for polymethacrylates are well known. By way of example, EP-A 0 113 924, EP-A 0 522 351, EP-A 0 465 049, EP-A 0 683 028 and U.S. Pat. No. 3,793,402 describe the preparation and structure of impact-modified polymethacrylate moulding compositions. By way of example, a suitable commercially available product is METABLEN® IR 441 from Mitsubishi Rayon.

### Impact Modifier

The polymethacrylate matrix preferably comprises from 1 to 30% by weight, preferably from 2 to 20% by weight, particularly preferably from 3 to 15% by weight, in particular from 5 to 12% by weight, of an impact modifier. These impact modifiers contain an elastomer phase which is composed of crosslinked polymer particles. The impact modifier is obtained in a manner known per se via bead polymerization or via emulsion polymerization.

The simplest case is that of crosslinked particles obtainable by means of bead polymerization with a median particle size in the range from 50 to 500 μm, preferably from 80 to 120 μm. These are generally composed of at least 40% by weight, preferably from 50 to 70% by weight, of methyl methacrylate, from 20 to 40% by weight, preferably from 25 to 35% by weight, of butyl acrylate, and also from 0.1 to 2% by weight, preferably from 0.5 to 1% by weight, of a crosslinking monomer, e.g. a polyfunctional (meth)acrylate, e.g. allyl methacrylate, and, where appropriate, other monomers, e.g. from 0 to 10% by weight, preferably from 0.5 to 8% by weight, of C₁-C₄-alkyl (meth)acrylates, such as ethyl acrylate or butyl acrylate, preferably methyl acrylate, or of other monomers capable of vinylic polymerization, e.g. styrene.

Preferred impact modifiers are polymer particles which have a core-shell structure comprising two, or particularly preferably three, layers, and which can be obtained via emulsion polymerization (see, for example, EP-A 0 113 924, EP-A 0 522 351, EP-A 0 465 049 and EP-A 0 683 028). Typical particle sizes (diameters) of these emulsion polymers are in the range from 100 to 500 nm, preferably from 200 to 450 nm.

The following method may be used to produce a three-layer or three-phase structure with a core and two shells. An innermost (hard) shell may, by way of example, be in essence composed of methyl methacrylate, very small proportions of comonomers, e.g. ethyl acrylate, and a proportion of crosslinking agent, e.g. allyl methacrylate. The middle (soft) shell may have a structure composed, by way of example, of butyl acrylate and, where appropriate, styrene, and also a proportion of crosslinking agent, e.g. allyl methacrylate, while the outermost (hard) shell is in essence mostly the same as the matrix polymer, thus giving compatibility and good bonding to the matrix.

The polybutyl acrylate fraction in the impact modifier is decisive for the impact resistance and is preferably in the range from 20 to 40% by weight, particularly preferably in the range from 25 to 40% by weight.

### Component f)

Component f) is an optional component which may be present alone or together with component g).

Component f) in the monomer composition may be identical to component d). Preparation may be substantially similar, except that the polymerization parameters are selected so as to give relatively high-molecular-weight polymers. By way of example, this may be achieved via a reduction in the amount of molecular weight regulator used.

Component f) is a relatively high-molecular-weight (meth)acrylate (co)polymer, characterized by a solution viscosity in chloroform at 25° C. (ISO 1628—Part 6) greater than or equal to 65 ml/g, preferably from 68 to 75 ml/g.

This can correspond to a molar mass M_{w} (weight-average) of 130 000 g/mol (M_{w} being determined by means of gel permeation chromatography with reference to polymethyl methacrylate as calibration standard). By way of example, the molar mass M_{w} may be determined by gel permeation chromatography or by a light scattering method (see, for example, H. F. Mark et al., Encyclopedia of Polymer Science and Engineering, 2^{nd} Edition, Vol. 10, pp. 1 et seq., J. Wiley, 1989).

Component f) in the monomer composition may be identical to component d). Component f) is preferably a copolymer of methyl methacrylate, styrene and maleic anhydride.

By way of example, suitable constituent proportions can be:
from 50 to 90% by weight, preferably from 70 to 80% by weight, of methyl methacrylate,
from 10 to 20% by weight, preferably from 12 to 18% by weight, of styrene and
from 5 to 15% by weight, preferably from 8 to 12% by weight, of maleic anhydride.

### Component g)

Component g) is an optional component which may be used alone or together with component f).

Component g) is a further (meth)acrylate (co)polymer other than d), characterized by a solution viscosity in chloroform at 25° C. (ISO 1628—Part 6) from 50 to 55 ml/g, preferably from 52 to 54 ml/g.

This can correspond to a molar mass M_{w} (weight-average) of from 80 000 to 200 000 (g/mol), preferably from 100 000 to 150 000 (g/mol). By way of example, the molar mass M_{w} may be determined by gel permeation chromatography or by a light scattering method (see, for example, H. F. Mark et al., Encyclopedia of Polymer Science and Engineering, 2^{nd} Edition, Vol. 10, pp. 1 et seq., J. Wiley, 1989).

Component g) is a homopolymer or copolymer of at least 80% by weight of methyl methacrylate and, where appropriate, up to 20% by weight of other monomers copolymerizable with methyl methacrylate.

Component g) is composed of from 80 to 100% by weight, preferably from 90 to 99.5% by weight, of free-radical-polymerized methyl methacrylate units and, where appropriate, from 0 to 20% by weight, preferably from 0.5 to 10% by weight, of other comonomers capable of free-radical polymerization, e.g. C₁-C₄-alkyl (meth)acrylates, in particular methyl acrylate, ethyl acrylate or butyl acrylate. The average molecular weight M_{w} of the matrix is preferably in the range from 90 000 to 200 000 g/mol, in particular from 100 000 to 150 000 g/mol.

Component g) is preferably a copolymer of from 95 to 99.5% by weight of methyl methacrylate and from 0.5 to 5% by weight, preferably from 1 to 4% by weight, of methyl acrylate.

Component g) may have a Vicat softening point VSP (ISO 306-B50) of at least 107° C., preferably from 108 to 114° C. The melt index MVR (ISO 1133, 230° C./3.8 kg) may, by way of example, be in the range greater than or equal to 2.5 cm³/10 min.

The Polymer Mixture Composed of Components d), e), f) and/or g)

The polymer mixture may therefore be composed either of components d), e) and f), or of components d), e) and g) or of all four of the components. Each of components d), e), f) and/or g) may be present in the form of an individual polymer or else of a mixture of two or more polymers complying with the corresponding definition.

Properties of the Polymer Mixture Composed of Components d), e), f) and/or g)

The quantitative proportions and the composition of components d), e), f) and/or g) are selected in such a way that a test specimen produced from the polymer mixture simultaneously has the following properties:
I. a tensile modulus (ISO 527) of at least 2600 MPa, preferably at least 2750 MPa, particularly preferably at least 2850 or 3000 MPa,
II. a Vicat softening point VSP (ISO 306-B50) of at least 109° C., preferably at least 110° C., in particular at least 112° C., e.g. from 110 to 125° C.,
III. an impact strength (ISO 179-2D, flatwise) of at least 17 kJ/m², preferably at least 18, 20, 25 or 30 kJ/m², and
IV. a melt index MVR (ISO 1133, 230° C./3.8 kg) of at least 1.5 cm³/10 min, preferably at least 1.65, 2.0 or 3.0 cm³/10 min.

Conventional additives, auxiliaries and/or fillers are to be selected in such a way as to cause no, or at most very slight, impairment of the abovementioned property profile.

### Other Properties

In addition, the constituent amounts of the components d), e) and f) and/or g), and their composition, are selected in such a way that a test specimen produced from the polymer mixture also has at least some of the following properties:

### Intrinsic Colour

Light transmittance T_{D65} to DIN 5033/7 of at least 50%, preferably at least 55%.

### Yellowness Index

The yellowness index which can be determined to DIN 6167 (illuminant D65, 10° on 3 mm layer thickness) is to be less than 20, preferably less than 17.

### Chemicals Resistance

Fracture time on wetting of the surface with isopropanol with constant outer fibre strain of
   0.39%: >1800 s
   0.50%: >700 s
Fracture time on wetting of the surface with ethanol/water mixture in a ratio of 70:30 at constant outer fibre strain of
   0.39%: >1800 s
   0.50%: >200 s

### Surface Hardness

Taber scratch hardness with applied force of
   0.7 N: no surface damage detectable
   1.5 N: <2.0 μm, preferably <1.6 μm
   3.0 N: <6 μm, preferably <5 μm

### Surface Gloss

R (60°): >48%, preferably >50%

### Quantitative Proportions of the Components

Components d), e), f) and/or g) are present in the following quantitative proportions, which give a total of 100% by weight.

Component d): from 25 to 75% by weight, preferably from 40 to 60% by weight, in particular from 45 to 55% by weight.

Component e): from 10 to 60% by weight, preferably from 10 to 20% by weight.

Component f) and/or g): from 10 to 50% by weight, preferably from 12 to 40% by weight.

Test specimens with very high VSP values in the range from 116 to 120° C. can be obtained if f) is present at from 30 to 45% by weight, preferably from 35 to 40% by weight and g) is preferably absent.

Test specimens with high VSP values, in the range from 114 to 118° C. together with high gloss, R(60°)=from 48 to 50, can be obtained if both f) and g) are present, the constituent proportions preferably being from 10 to 15% by weight of f) and from 15 to 25% by weight of g).

Test specimens with VSP values in the range from 109 to 113° C. together with a very low level of intrinsic colour, and light transmittance T_{D65} to DIN 5033/7 in the range from 60 to 65% can be obtained if g) is present at from 30 to 40% by weight, preferably from 33 to 38% by weight and f) is preferably absent.

The polymer mixture can also comprise conventional additives, auxiliaries and/or fillers.

### Preparation of the Inventive Polymer Mixture

The inventive polymer mixture composed of a), b) and c), and also the polymer mixture which can be used as polymer matrix a) and impact modifier b) and which is composed of components d), e), f) and/or g), may be prepared via dry blending of the components, which are in pulverulent, granular, or preferably pelletized, form.

The inventive polymer mixture composed of a), b) and c), and also the polymer mixture which can be used as polymer matrix a) and impact modifier b) and which is composed of components d), e), f) and/or g) may also be processed via melting and mixing of the individual components in the molten state or via melting of dry premixes of the individual components to give a ready-to-use moulding composition. By way of example, this may take place in single- or twin-screw extruders. The resultant extrudate may then be pelletized. Conventional additives, auxiliaries and/or fillers may be admixed directly or added subsequently by the final user as required.

Conventional Additives, Auxiliaries and/or Fillers

The inventive polymer mixture composed of a), b) and c), and also the polymer mixture which may be used as polymer matrix a) and impact modifier b) and which is composed of components d), e), f) and/or g) may also, in a manner known per se, comprise conventional additives, auxiliaries and/or fillers, e.g. heat stabilizers, UV stabilizers, UV absorbers, antioxidants. The inventive polymer mixture composed of a), b) and c) may in particular comprise soluble dyes or insoluble colorants.

### UV Stabilizers and Free-Radical Scavengers

Examples of UV stabilizers optionally present are derivatives of benzophenone, whose substituents, such as hydroxyl and/or alkoxy groups, are mostly in the 2- and/or 4-position. Among these are 2-hydroxy-4-n-octoxybenzophenone, 2,4-dihydroxybenzophenone, 2,2′-dihydroxy-4-methoxybenzophenone, 2,2′,4,4′-tetra-hydroxybenzophenone, 2,2′-dihydroxy-4,4′-dimethoxy-benzophenone, 2-hydroxy-4-methoxybenzophenone. Other very suitable UV stabilizer additives are substituted benzotriazoles, among which are in particular 2-(2-hydroxy-5-methylphenyl)benzotriazole, 2-[2-hydroxy-3,5-di(alpha,alpha-dimethylbenzyl)phenyl]benzotriazole, 2-(2-hydroxy-3,5-di-tert-butylphenyl)benzotriazole, 2-(2-hydroxy-3,5-butyl-5-methylphenyl)-5-chlorobenzo-triazole, 2-(2-hydroxy-3,5-di-tert-butylphenyl)-5-chlorobenzotriazole, 2-(2-hydroxy-3,5-di-tert-amyl-phenyl)benzotriazole, 2-(2-hydroxy-5-tert-butyl-phenyl)benzotriazole, 2-(2-hydroxy-3-sec-butyl-5-tert-butylphenyl)benzotriazole and 2-(2-hydroxy-5-tert-octylphenyl)benzotriazole.

Other UV stabilizers which may be used are ethyl 2-cyano-3,3-diphenylacrylate, 2-ethoxy-2′-ethyl-oxanilide, 2-ethoxy-5-tert-butyl-2′-ethyloxanilide and substituted phenyl benzoates.

The UV stabilizers may be present in the form of low-molecular-weight compounds as given above in the polymethacrylate compositions to be stabilized. However, there may also be UV-absorbent groups covalently bonded within the matrix polymer molecules after copolymerization with polymerizable UV-absorption compounds, e.g. acrylic, methacrylic or allyl derivatives of benzophenone derivatives or of benzotriazole derivatives. The proportion of UV stabilizers, which may also be mixtures of chemically different UV stabilizers, is generally from 0.01 to 1% by weight, especially from 0.01 to 0.5% by weight, in particular from 0.02 to 0.2% by weight, based on the entirety of all of the constituents of the inventive polymethacrylate resin.

Examples which may be mentioned here of free-radical scavengers/UV stabilizers are sterically hindered amines, known as HALS (Hindered Amine Light Stabilizers). They may be used for inhibiting ageing processes in paints and in plastics, especially in polyolefins (Kunststoffe [Plastics], 74 (1984) 10, pp. 620-623; Farbe+Lack, Volume 96, 9/1990, pp. 689-693). The tetramethylpiperidine group present in the HALS compounds is responsible for their stabilizing action. This class of compound may have no substitution on the piperidine nitrogen, or else has alkyl or acyl substitution thereon. The sterically hindered amines do not absorb in the UV range. They scavenge free radicals, this being a function of which the UV absorbers are in turn not capable.

Examples of stabilizing HALS compounds which can also be used in the form of mixtures are: Bis(2,2,6,6-tetramethyl-4-piperidyl) sebacate, 8-acetyl-3-dodecyl-7,7,9,9-tetramethyl-1,3,8-triazaspiro[4.5]decane-2,5-dione, bis(2,2,6,6-tetramethyl-4-piperidyl) succinate, the polymer of the succinic ester of N-β-hydroxyethyl-2,2,6,6-tetramethyl-4-hydroxypiperidine or bis(N-methyl-2,2,6,6-tetra-methyl-4-piperidyl) sebacate.

The amounts of the free-radical scavengers/UV stabilizers used in the inventive polymer mixtures are from 0.01 to 1.5% by weight, especially from 0.02 to 1% by weight, in particular from 0.02 to 0.5% by weight, based on the entirety of all of the constituents.

### Lubricants or Mould-Release Agents

Lubricants or mould-release agents are particularly important for the injection-moulding process, and can reduce or entirely eliminate any possible adhesion of the polymer mixture to the injection mould.

Lubricants may therefore be present as auxiliaries, by way of example selected from the group of the saturated fatty acids having fewer than 20 carbon atoms, preferably from 16 to 18 carbon atoms, or of the saturated fatty alcohols having fewer than 20 carbon atoms, preferably from 16 to 18 carbon atoms. Preference is given to the presence of very small constituent amounts of at most 0.25% by weight, e.g. from 0.05 to 0.2% by weight, based on the polymer mixture.

Examples of suitable materials are stearic acid, palmitic acid, industrial mixtures composed of stearic and palmitic acid. Examples of other suitable materials are n-hexadecanol, n-octadecanol, and also industrial mixtures composed of n-hexadecanol and n-octadecanol.

Stearyl alcohol is a particularly preferred lubricant or mould-release agent.

### Impact Modifier b)

The polymer mixture comprises an impact modifier based on crosslinked poly(meth)acrylates and with no covalent bonding to the polymer matrix a). Component b) preferably has a two- or three-shell structure.

Impact modifiers for polymethacrylates are well known. By way of example, EP-A 0 113 924, EP-A 0 522 351, EP-A 0 465 049, EP-A 0 683 028 and U.S. Pat. No. 3,793,402 describe the preparation and structure of impact-modified polymethacrylate moulding compositions. An example of a suitable commercially available product is METABLEN® IR 441 from Mitsubishi Rayon.

The polymer mixture may comprise from 5 to 60% by weight, preferably from 10 to 20% by weight, particularly preferably from 10 to 15% by weight, of an impact modifier which is an elastomer phase composed of crosslinked polymer particles. The impact modifier is obtained in a manner known per se via bead polymerization or via emulsion polymerization.

In the simplest case, these are crosslinked particles obtainable by means of bead polymerization with a median particle size in the range from 50 to 500 μm, preferably from 80 to 120 μm. These are generally composed of at least 40% by weight, preferably from 50 to 70% by weight, of methyl methacrylate, from 20 to 40% by weight, preferably from 25 to 35% by weight, of butyl acrylate, and also from 0.1 to 2% by weight, preferably from 0.5 to 1% by weight, of a crosslinking monomer, e.g. a polyfunctional (meth)acrylate, e.g. allyl methacrylate, and, where appropriate, of other monomers, e.g. from 0 to 10% by weight, preferably from 0.5 to 8% by weight, of C₁-C₄-alkyl (meth)acrylates, such as ethyl acrylate or butyl acrylate, preferably methyl acrylate, or of other monomers capable of vinylic polymerization, e.g. styrene.

Preferred impact modifiers are polymer particles which have a two-layer core-shell structure, particularly preferably a three-layer core-shell structure, and can be obtained via emulsion polymerization (see, for example, EP-A 0 113 924, EP-A 0 522 351, EP-A 0 465 049 and EP-A 0 683 028). Typical particle sizes for these emulsion polymers are in the range from 100 to 500 nm, preferably from 200 to 450 nm.

A three-layer or three-phase structure with a core and two shells can be created as follows. By way of example, an innermost (hard) shell may be composed in essence of methyl methacrylate, small proportions of comonomers, e.g. ethyl acrylate, and a proportion of crosslinking agent, e.g. allyl methacrylate. The middle (soft) shell may, by way of example, be composed of butyl acrylate and, where appropriate, styrene, and also of a proportion of crosslinking agent, e.g. allyl methacrylate, while the outermost (hard) shell is in essence mostly identical with the matrix polymer, thus bringing about compatibility and good bonding to the matrix. The polybutyl acrylate fraction in the impact modifier is decisive for impact-modifying action and is preferably in the range from 20 to 40% by weight, particularly preferably in the range from 25 to 40% by weight.

### Matting Agent c): Plastics Particles Composed of Crosslinked Polymers Based on Polymethyl Methacrylate, on Polystyrene or on Polysilicones

The polymer mixture comprises from 1 to 15% by weight, preferably from 1 to 12% by weight, of plastics particles composed of crosslinked polymers based on polymethyl methacrylate, on polystyrene and/or on polysilicones, with an median particle size in the range from 1 to 30 μm, preferably from 2 to 20 μm, in particular from 3 to 15 μm.

A laser extinction method may be used to determine the particle size, and also the particle size distribution. Use may be made here of a Galay-CIS from L.O.T. GmbH, the user manual for which gives the measurement method for determining particle size and particle size distribution. The median particle size V₅₀ is the ponderal median, where the value for 50% by weight of the particles is smaller than or identical to this value and that for 50% by weight of these particles is greater than or identical to this value.

There is no particular restriction on the plastics particles which may be used according to the invention. The nature of the plastic from which the plastics particles are produced is therefore substantially non-critical.

One group of preferred plastics particles which may be used as matting agent is those comprising silicones. By way of example, these particles are obtained via hydrolysis and polycondensation of organotrialkoxy-silanes and/or of tetraalkoxysilanes, these being described by the formulae

R¹Si(OR²)₃ and Si(OR²)₄

where R¹ is, by way of example, a substituted or unsubstituted alkyl group, an alkenyl group or a phenyl group, and the radical R² of the hydrolysable alkoxy group is an alkyl group, such as methyl, ethyl or butyl, or an alkoxy-substituted hydrocarbon group, such as 2-methoxyethyl or 2-ethoxyethyl. Examples of organo-trialkoxysilanes are methyltrimethoxysilane, methyl-triethoxysilane, methyl-n-propoxysilane, methyltriiso-propoxysilane and methyltris(2-methoxyethoxy)silane.

The abovementioned silane compounds, and processes for the production of spherical silicone particles, are known to those skilled in the art and are described in the specifications EP 1 116 741, JP 63-077940 and JP 2000-186148.

Matting agents composed of silicone and particularly preferably used in the present invention are obtainable from GE Bayer Silicones with the trade names TOSPEARL® 120 and TOSPEARL® 3120.

The structure of another group of preferred plastics particles comprises, on the condition that b1) and/or b2) must be present:
b1) from 0 to 99.9 parts by weight of monomers which have aromatic groups as substituents, for example styrene, α-methylstyrene, ring-substituted styrenes, phenyl (meth)acrylate, benzyl (meth)acrylate, 2-phenylethyl (meth)acrylate, 3-phenylpropyl (meth)acrylate or vinyl benzoate; and also
b2) from 0 to 99.9 parts by weight of an acrylic and/or methacrylic ester having 1 to 12 carbon atoms in the aliphatic ester radical, these being copolymerizable with the monomers b1), and mention may be made here of the following by way of example: methyl (meth)acrylate, ethyl (meth)-acrylate, n-propyl (meth)acrylate, isopropyl (meth)acrylate, n-butyl (meth)acrylate, isobutyl (meth)acrylate, tert-butyl (meth)acrylate, cyclo-hexyl (meth)acrylate, 3,3,5-trimethylcyclohexyl (meth)acrylate, 2-ethylhexyl (meth)acrylate, norbornyl (meth)acrylate or isobornyl (meth)-acrylate;
b3) from 0.1 to 15 parts by weight of crosslinking comonomers which have at least two ethylenically unsaturated groups copolymerizable by a free-radical route with b1) and/or with b2), examples being divinylbenzene, glycol di(meth)acrylate, 1,4-butanediol di(meth)acrylate, allyl (meth)acrylate, triallyl cyanurate, diallyl phthalate, diallyl succinate, pentaerythritol tetra(meth)acrylate or trimethylolpropane tri-(meth)acrylate, where the amounts of the comonomers b1), b2) and b3) give a total of 100 parts by weight.

Examples of suitable plastics particles are those composed of at least 80% by weight of styrene and at least 0.5% by weight of divinylbenzene.

The production of crosslinked plastics particles is known to those skilled in the art. For example, the scattering particles may be produced by emulsion polymerization, for example as described in EP-A 342 283 or EP-A 269 324, and very particularly preferably via organic-phase polymerization, for example as described in the German Patent Application P 43 27 464.1. The last-mentioned polymerization technique gives particularly narrow particle size distributions or, in other words, particularly small deviations of the particle diameters from the median particle diameter.

It is particularly preferable to use plastics particles whose heat resistance extends to at least 200° C., in particular at least 250° C., with no intended resultant restriction. The term heat-resistant here means that the particles are not subject to any substantial thermal degradation. Thermal degradation causes undesirable discoloration making the plastics material unusable.

Particularly preferred particles are, inter alia, obtainable from Sekisui with the trade names ®Techpolymer SBX-6, ®Techpolymer SBX-8, ®Techpolymer SBX-12 and ®Techpolymer MBX-8.

The scattering particles described above may be used individually or as a mixture of two or more types.

A laser extinction method may be used to determine the particle size, and also the particle size distribution. Use may be made here of a Galay-CIS from L.O.T. GmbH, the user manual for which gives the measurement method for determining particle size and particle size distribution. The median particle size V₅₀ is the ponderal median, where the value for 50% by weight of the particles is smaller than or identical to this value and that for 50% by weight of these particles is greater than or identical to this value.

### Process for Producing Injection Mouldings

The inventive polymer mixture is a suitable starting material for processes for producing injection mouldings in a manner known per se. Matt mouldings are obtained here when using injection moulds whose mould cavities have smooth or mirror-polished inner surfaces (cavities). Even more intensely matt mouldings are obtained when using injection moulds whose mould cavities have rough internal surfaces (cavities).

### Injection Mouldings

The polymer mixture may be used to produce injection mouldings which have the following properties:

The inventive injection mouldings have a roughness value R_{z} to DIN 4768 of at least 0.7 μm, preferably from 1.0 to 2.0 μm. The gloss (R 60°) to DIN 67530 (01/1982) is at most 40, preferably at most 38, in particular from 30 to 38. Depending on the matrix plastic used, the Vicat softening point VSP (ISO 306-B50) is at least 90° C., preferably at least 95° C., particularly preferably at least 100° C., in particular from 90 to 120° C., from 115 to 135° C., from 130 to 170° C. Other particular properties may be:
I. a tensile modulus (ISO 527) of at least 2600 MPa,
II. a Vicat softening point VSP (ISO 306-B50) of at least 108° C.,
III. an impact strength (ISO 179-2D, flatwise) of at least 10 kJ/m², and
IV. a melt index MVR (ISO 1133, 230° C./3.8 kg) of at least 0.5 cm³/10 min.

### Uses

The injection mouldings may be used as parts of household appliances, of communication devices, or of devices for hobbies or sports, or as bodywork parts or parts of bodywork parts in the construction of automobiles, of ships or of aircraft. Examples of typical automotive exterior parts are spoilers, paneling, roof modules and exterior mirror housings.

### Advantageous Effects of the Invention

The inventive polymer mixtures or inventive moulding compositions may be used to produce matt mouldings, in particular injection-moulded parts, the material of which complies with stringent requirements, for example those for automotive exterior parts. Four particularly important requirements: tensile modulus, Vicat softening point, impact strength, and melt index have successfully been provided here simultaneously with orders of magnitude suitable for processing and use. In particular, the good flowability provides the required processability in injection moulding, even for parts with difficult geometry. It is surprising that the injection-moulded parts which can be obtained here simultaneously have high and sufficient toughness, high weathering resistance and high heat resistance. In addition, a series of other desirable properties are also achieved in a highly satifactory manner, e.g. chemicals resistance, yellowness index and intrinsic colour. The property profile can be individually adjusted to the requirements of a particular case by way of the mixing ratio of components a) to c).

### EXAMPLES

Polymer Matrix a)+Impact Modifier b)

Use is made of a mixture of (meth)acrylate (co)polymers which is composed of components d), e) and f), where component e) is an impact modifier based on crosslinked poly(meth)acrylates and having no covalent bonding to the matrix, and therefore corresponding to component b) of the inventive polymer mixture. Components d) and f) represent the polymer matrix a).

### Preparation of Component d):

A monomer mixture of 6355 g of methyl methacrylate, 1271 g of styrene and 847 g of maleic anhydride is treated with 1.9 g of tert-butyl perneodecanoate and 0.85 g of tert-butyl 3,5,5-trimethylperoxyhexanoate as polymerization initiator and 19.6 g of 2-mercaptoethanol as molecular weight regulator and also with 4.3 g of palmitic acid.

The resultant mixture is charged to a polymerization cell and devolatilized for 10 minutes. It is then polymerized in a water bath for 6 hours at 60° C., and then for 30 hours at 55° C. water bath temperature. After about 30 hours the polymerization mixture reaches its maximum temperature of 126° C. Once the polymerizatin cell has been removed from the water bath, the polymer is heat-conditioned in the polymerization cell for a further 7 hours at 117° C. in a hot-air cabinet.

The resultant copolymer is clear and almost colourless, and has a VN (solution viscosity number to ISO 1628-6, 25° C., chloroform) of 48.7 ml/g. The flowability of the copolymer was determined to ISO 1133 at 230° C. and 3.8 kg as MVR=3.27 cm³/10 min.

Component d) is the copolymer described above composed of 75% by weight of methyl methacrylate, 15% by weight of styrene and 10% by weight of maleic anhydride.

The component e) used comprised: a commercially available impact modifier, METABLEN® IR 441 from Mitsubishi Rayon, thus corresponding to component b) of the inventive polymer mixture.

The component f) used comprised: a commercially available copolymer composed of 75% by weight of methyl methacrylate, 15% by weight of styrene and 10% by weight of maleic anhydride with a solution viscosity number to ISO 1628-6, 25° C., chloroform, of 68 ml/g

### Matting Agent c)

Various matting agents were used

### Matting Agent 1)

Commercially available product ACEMATT® OP278 (Degussa AG)

This is a bead polymer whose particle size is about 200 μm. In these beads, a PMMA matrix comprises particles of size about 7 μm composed of crosslinked styrene-butyl acrylate copolymer (styrene/butyl acrylate ratio=66.7/33.3). The ratio of the matrix to the crosslinked particles is 27:73. These fine particles act as matting agent—the matrix material is digested during the compounding process.

### Matting Agent 2)

A bead polymer of size about 20 μm composed of crosslinked polymer, mainly composed of methyl methacrylate and benzyl methacrylate.

### Matting Agent 3)

The bead polymer particles of size about 45 μm are composed of a crosslinked methyl methacrylate-styrene copolymer.

### Matting Agent 4)

Commercially available product Techpolymer® SBX 8, Sekisui Plastics Co., Ltd.: particles of size about 8 μm composed of crosslinked polystyrene.

### Blending of the Moulding Compositions

The polymer blend is blended by means of an extruder with the respective matting agents. Table 1 gives the compositions for each example.

### Testing of the Moulding Compositions

Test specimens were produced by injection moulding from the blended moulding compositions. The appropriate test specimens were tested by the following methods:
MVR (230° C./3.8 kg): Determination of volume flow index, test standard ISO 1133: 1997
Viscosity ηs (220° C./5 MPa): Determination of melt viscosity, test standard: DIN 54811: 1984
Die swell B: Determination of die swell, test standard: DIN 54811: 1984
VSP (16 h/80° C.): Determination of Vicat softening point using the Vicat system—test standard DIN ISO 306-B50: August 1994
Impact strength: Determination of Charpy impact strength, test standard: ISO 179 edgewise
Modulus of elasticity: Determination of modulus of elasticity, test standard: ISO 527-2
Gloss: Measurement of gloss to DIN 67530 (01/1982):
   “Reflectometer as a means for gloss assessment of plane surfaces of paint coatings and plastics”
Surface roughness: Roughness variables Rₐ, R_{Z} and Rₘₐₓ to DIN 4768. It is also advisable here to state the cut-off: Rₐ values <2 μm are determined with a cut-off of 0.8 mm, and if Rₐ is greater than 2 μm the cut-off used is 2.5 mm.

The size of the test specimens for determining gloss and surface roughness is 110×110×3 mm, and they were produced using a mirror-polished cavity (DEMAG D150 injection-moulding machine, Demag; melt temperature 250° C., mould temperature 70° C., injection pressure: 120-160 bar, hold pressure: 75-80 bar). The gloss measurements were carried out using an RL laboratory reflectometer from Dr. Lange, and the roughness measurements were carried out using the Form Talysurf 50 produced by Rank Taylor Hobson GmbH.

Table 2 gives the results of the tests on the blends and on the corresponding mouldings. The examples clearly show the improvements achieved via the invention described here:
The use of matting agents with particle sizes of from 6 to 20 μm at concentrations of from 5 to 10% (see inventive examples 1, 2, 3 and 4) in the matrix markedly reduces gloss (reflectance values at 60° from 89.9 to 31-38). This effect is also markedly apparent in the rise in roughness (R_{z} from 0.09 to 0.73-1.28 μm).
In addition, the Vicat softening point is not lowered by any more than 7° C. (6%). The mechanical properties of the mouldings moreover remain at an acceptable level, and the processability of the moulding compositions is similar to that of the starting material (see rheological values).
When use is made of coarser matting agents in a similar range of concentrations (12%, comparative example 2), the roughness also increases markedly, but the surface is no longer satin-matt to fine-grained, but is coarse-grained. In addition, gloss at 60° is not so effectively reduced as with the matting

TABLE 1
Composition for each example (amounts weighed out in kg)

| | Comparative | Comparative | | | | |
|---|---|---|---|---|---|---|
| | Ex. 1 | Ex. 2 | Inv. Ex. 1 | Inv. Ex. 2 | Inv. Ex. 3 | Inv. Ex. 4 |
| Polymer blend | | | | | | |
| Component f) | 36.8 | 36.8 | 36.8 | 36.8 | 36.8 | |
| Component d) | 50.0 | 50.0 | 50.0 | 50.0 | 50.0 | |
| Component e) = b) | 13.0 | 13.0 | 13.0 | 13.0 | 13.0 | |
| Impact modifier | | | | | | |
| Stearyl alcohol | 0.2 | 0.2 | 0.2 | 0.2 | 0.2 | |
| Matting agent | | | | | | |
| Matting agent 1: ACEMATT ® OP278 | | | 5.26 | 11.11 | | |
| Matting agent 2 | | | | | 11.1 | |
| Matting agent 3 | | 13.63 | | | | |
| Matting agent 4: Techpolymer ® | | | | | | 11.1 |
| SBX-8 | | | | | | |

The inventive examples and comparative examples were coloured black:
For this, additional use was made of 0.39% of Thermoplastic Blue 684, 0.21% of Thermoplastic Yellow 104 and 0.23% of Printex 140 V Degussa based on the matrix (polymer blend) during compounding of the polymer blends.

TABLE 2
Test results from the injection-moulded parts and from the corresponding mouldings

| | Comparative | Comparative | | | | |
|---|---|---|---|---|---|---|
| | Ex. 1 | Ex. 2 | Inv. Ex. 1 | Inv. Ex. 2 | Inv. Ex. 3 | Inv. Ex. 4 |
| Gloss | | | | | | |
| R (20°) | 83.2 | 12.7 | 8.9 | 6.4 | 8.9 | 7 |
| R (60°) | 89.9 | 42.3 | 38 | 31 | 35.6 | 33.2 |
| R (85°) | 99.1 | 66.1 | 72.3 | 68.1 | 61.7 | 68.5 |
| Roughness | | | | | | |
| Average roughness value Rₐ [μm] | 0.01 | 0.14 | 0.12 | 0.2 | 0.14 | 0.17 |
| Average roughness depth R_{z} [μm] | 0.09 | 1.03 | 0.73 | 1.17 | 1.28 | 1.26 |
| Max. roughness depth Rₘₐₓ [μm] | 0.11 | 1.49 | 0.97 | 1.56 | 1.69 | 1.62 |
| Visual assessment of | smooth, | coarse- | satin-matt | satin-matt | fine- | satin-matt |
| injection-moulded sheets | glossy | grained | | | grained | |
| Mechanical properties | | | | | | |
| Charpy impact strength [kJ/m²] | 20 | 17.2 | 17.9 | 14.9 | 18 | 11.6 |
| (23/50° C.) | | | | | | |
| Modulus of elasticity [MPa] | 2990 | 3060 | 2970 | 2820 | 3060 | 3050 |
| (1 mm/min) | | | | | | |
| Heat resistance | | | | | | |
| VSP (Minivicat B) | 117 | 115 | 114 | 110 | 114 | 117 |
| Rheology | | | | | | |
| Viscosity eta s [Pa s] | 2720 | 3160 | 2310 | 2130 | 3200 | 3360 |
| Die swell B [%] | 72 | 52 | 72 | 73 | 53 | 49 |
| MVR [cm³/10 min] | 2 | 1.4 | 2.1 | 2.3 | 1.5 | 1.5 |

1. A polymer mixture, comprising:
a) a polymer matrix which consists essentially of:
i) a (meth)acrylate (co)polymer with a Vicat softening point (ISO 306-B50) of at least 104° C.; or
ii) a mixture of (meth)acrylate (co)polymers with a Vicat softening point (ISO 306-B50) of at least 104° C.; or
iii) a (meth)acrylimide (co)polymer; or
iv) mixtures of a (meth)acrylimide (co)polymer (iii) with (i) or (ii);
b) an impact modifier which is based on crosslinked poly(meth)acrylates and which is not covalently bonded to the polymer matrix a);
c) from 1 to 15% by weight of plastics particles composed of crosslinked polymers based on polymethyl methacrylate, on polystyrene and/or on polysilicones, with a median particle size in the range from 1 to 30 μm,
wherein a), b) and c) give a total of 100% by weight, and
wherein the polymer mixture may also comprise conventional additives, auxiliaries and/or fillers, and a test specimen injection-moulded from the polymer mixture simultaneously has the following properties:
a roughness value R_{z} to DIN 4768 of at least 0.7 μm;
a gloss (R 60°) to DIN 67530 of at most 40; and
a Vicat softening point (ISO 306-B50) of at least 90° C.

2. The polymer mixture according to claim 1, wherein the components are present with the following quantitative proportions:
a) from 25 to 75% by weight;
b) from 5 to 60% by weight; and
c) from 1 to 15% by weight.

3. The polymer mixture according to claim 1, wherein the impact modifier b) has a two- or three-shell structure.

4. A polymer mixture according to claim 1, wherein the polymer matrix a) consists essentially of a (meth)acrylate (co)polymer composed of 96 to 100% by weight of methyl methacrylate and 0 to 4% by weight of methyl acrylate, ethyl acrylate and/or butyl acrylate.

5. The polymer mixture according to claim 1, wherein the polymer matrix a) is a copolymer consists essentially of methyl methacrylate, styrene and maleic anhydride.

6. The polymer mixture according to claim 5, wherein the polymer matrix a) is a copolymer consisting essentially of:
from 50 to 90% by weight of methyl methacrylate;
from 10 to 20% by weight of styrene; and
from 5 to 15% by weight of maleic anhydride.

7. The polymer mixture according to claim 1, wherein the constituents polymer matrix material a) and impact modifier material b) of the polymer mixture are introduced individually or in the form of a compounded material into the polymer mixture, wherein the polymer matrix material a) is one or more of the following poly(meth)acrylate components d), f) and g) and that impact modifier b) is impact modifier e):
d) a low-molecular-weight (meth)acrylate (co)polymer with a Vicat softening point (ISO 306-B50) of at least 104° C., characterized by a solution viscosity in chloroform at 25° C. (ISO 1628—Part 6) smaller than or equal to 55 ml/g;
e) an impact modifier based on crosslinked poly(meth)acrylates;
f) a relatively high-molecular-weight (meth)acrylate (co)polymer with a Vicat softening point (ISO 306-B50) of at least 104° C., characterized by a solution viscosity in chloroform at 25° C. (ISO 1628—Part 6) smaller than or equal to 65 ml/g; and/or
g) a (meth)acrylate (co)polymer other than d) with a Vicat softening point (ISO 306-B50) of at least 104° C., characterized by a solution viscosity in chloroform at 25° C. (ISO 1628—Part 6) of 50 to 55 ml/g;
wherein each of the components d), e), 0 and/or g) may be an individual polymer or else a mixture of polymers,
wherein d), e), f) and/or g) give a total of 100% by weight;
wherein the polymer mixture optionally comprises conventional additives, auxiliaries and/or fillers; and
wherein a test specimen produced from the polymer mixture of components d), e), f) and/or g) simultaneously has the following properties:
a tensile modulus (ISO 527) of at least 2600 MPa;
a Vicat softening point (ISO 306-B50) of at least 109° C.;
an impact strength (ISO 179-2D, flatwise) of at least 17 kJ/m²; and
a melt index (ISO 1133, 230° C./3.8 kg) of at least 1.5 cm³/10 min.

8. The polymer mixture according to claim 7, wherein the components are present with the following quantitative proportions and give a total of 100% by weight:
d) from 25 to 75% by weight;
e) from 10 to 60% by weight;
f) and/or g) from 10 to 50% by weight.

9. The polymer mixture according to claim 7, wherein component d) is a copolymer composed of methyl methacrylate, styrene and maleic anhydride.

10. The polymer mixture according to claim 9, wherein component d) is a copolymer composed of:
50 to 90% by weight of methyl methacrylate;
10 to 20% by weight of styrene; and
5 to 15% by weight of maleic anhydride.

11. The polymer mixture according to claim 7, wherein component e) has a two- or three-shell structure.

12. The polymer mixture according to claim 7, wherein component f) is a copolymer composed of methyl methacrylate, styrene and maleic anhydride.

13. The polymer mixture according to claim 12, wherein component f) is a copolymer composed of:
50 to 90% by weight of methyl methacrylate;
10 to 20% by weight of styrene; and
5 to 15% by weight of maleic anhydride.

14. The polymer mixture according to claim 7, wherein component g) is a homopolymer or copolymer composed of at least 80% by weight of methyl methacrylate and, optionally, up to 20% by weight of other monomers copolymerizable with methyl methacrylate.

15. The polymer mixture according to claim 14, wherein component g) is a copolymer composed of 95 to 99.5% by weight of methyl methacrylate and 0.5 to 5% by weight of methyl acrylate, ethyl acrylate and/or butyl acrylate.

16. The polymer mixture according to claim 1, wherein a lubricant is present as an auxiliary.

17. The polymer mixture according to claim 15, wherein stearyl alcohol is present as a mould-release agent.

18. The polymer mixture according to claim 1, wherein the polymer mixture takes the form of a pelletized moulding composition.

19. A process for producing an injection moulded article, which comprises:
injection molding the polymer mixture according to claim 1 into the shape of an object.

20. An injection moulded article as prepared by the process according to claim 19.

21. The injection moulding according to claim 19, wherein the injection moulded article has a roughness value Rz to DIN 4768 of at least 0.7 μm, a gloss (R 60°) to DIN 67530 of at most 40 and a Vicat softening point (ISO 306-B50) of at least 90° C.

22. The injection moulded article according to claim 19, wherein the injection moulded article has one or more of the following properties:
a tensile modulus (ISO 527) of at least 2600 MPa;
a Vicat softening point (ISO 306-B50) of at least 108° C.;
an impact strength (ISO 179-2D, flatwise) of at least 10 kJ/m²; and
a melt index (ISO 1133, 230° C./3.8 kg) of at least 0.5 cm³/10 min.

23. The injection moulded article according to claim 19, wherein the injection moulded article is a part of a household appliance, communication device, device for hobbies or sports, or a bodywork part or a part of bodywork parts in the construction of automobiles, ships or aircraft.

24. A polymer mixture, consisting essentially of:
a) a polymer matrix which is composed of:
i) a (meth)acrylate (co)polymer with a Vicat softening point (ISO 306-B50) of at least 104° C.; or
ii) a mixture of (meth)acrylate (co)polymers with a Vicat softening point (ISO 306-B50) of at least 104° C.; or
iii) a (meth)acrylimide (co)polymer; or
iv) mixtures of a (meth)acrylimide (co)polymer (iii) with (i) or (ii);
b) an impact modifier which is based on crosslinked poly(meth)acrylates and which does not have covalent bonding to the polymer matrix a);
c) from 1 to 15% by weight of plastics particles composed of crosslinked polymers based on polymethyl methacrylate, on polystyrene and/or on polysilicones, with a median particle size in the range from 1 to 30 μm,
wherein a), b) and c) give a total of 100% by weight, and
wherein the polymer mixture may also comprise conventional additives, auxiliaries and/or fillers, and a test specimen injection-moulded from the polymer mixture simultaneously has the following properties:
a roughness value R_{z} to DIN 4768 of at least 0.7 μm;
a gloss (R 60°) to DIN 67530 of at most 40; and
a Vicat softening point (ISO 306-B50) of at least 90° C.
